(19) United States
(12) Patent Application Publication
(10) Pub. No.: US 2012/0162356 A1
(43) Pub. Date: Jun. 28, 2012

(54) IMAGE PROCESSING SYSTEM

(75) Inventors: Karl Catharina Van Bree, Eindhoven (NL); Harm Jan Willem Belt, Eindhoven (NL)

(73) Assignee: KONINKLIJKE PHILIPS ELECTRONICS N.V., EINDHOVEN (NL)

(21) Appl. No.: 13/392,680

(22) PCT Filed: Sep. 2, 2010
(86) PCT No.: PCT/IB10/53953

§ 371 Date: Feb. 27, 2012

(30) Foreign Application Priority Data
Sep. 11, 2009 (EP) 09170035.1

(51) Int. Cl. G06K 9/68; H04N 7/14

(52) U.S. Cl. 348/14.16; 382/103; 348/E07.078

(57) ABSTRACT

The present invention relates to a method for an image processing system (100), the method comprising the steps of acquiring (S1) a first image (I₁) of a first person, locating (S2) a first segment (202, 204) in the first image (I₁) comprising at least an eye of the first person, acquiring (S3) a second image (I₂) of a second person, locating (S4) a second segment (206, 208) in the second image (I₂) comprising at least an eye of the second person, the second segment corresponding in relative position and size to the first segment (202, 204), comparing the second segment (206, 208) with the first segment (202, 204), and replacing the second segment (206, 208) in the second image (I₂) with the first segment (202, 204) if the comparison gives a difference that is smaller than a pre-defined threshold. The present invention allows for replacements of segments of the face with pre-recorded corresponding segments having characteristics for improving eye-to-eye contact in e.g. a near-end/far-end user video conferencing system.

### FIELD OF THE INVENTION

The present invention relates to a method for an image processing system. The present invention also relates to a corresponding image processing system.

### BACKGROUND OF THE INVENTION

In face-to-face communication eye gaze awareness is of high social importance. However, in typical video conferencing and video telephony applications between a near-end user and a far-end user eye gaze awareness often is lost.

This is generally due to the fact that the image capturing video camera is placed on top of the display screen and the user instinctively looks straight into their display screen showing the participant on the other end rather than towards the camera. As a result, in an image captured using a video camera at the near-end user and displayed on the display screen of the far-end user, the near-end user will appear to be looking astray. Accordingly, the far-end user will not feel being looked at because the near-end participant seems to be looking astray.

Studies have shown that already an “error angle” a in eye gaze direction, e.g. resulting from placement of the camera on top of the display and the user looking straight into the display screen, exceeding 8 degrees will result in loss of eye contact.

Different methods have been introduced for coping with the above problem, and an example of such a method is disclosed in U.S. Pat. No. 5,675,376. In U.S. Pat. No. 5,675,376 the iris positions of a users eyes are detected for determining the respective eye gaze directions, and when correction of eye gaze directions are needed the image pixels corresponding to the iris positions are “shifted” to achieve eye-to-eye contact.

However, even though the method disclosed in U.S. Pat. No. 5,675,376 provides some improvements to the above discussed problem it introduces unwanted complexity and reliability issues due to the analysis of the iris position and great precision needed for the pixel shift operation. Accordingly, there is therefore a need for an improved method at least alleviates the problem with loss of eye contact in video conferencing and video telephony applications between a near-end user and a far-end user.

### SUMMARY OF THE INVENTION

According to an aspect of the invention, the above is at least partly met by a method for an image processing system, the method comprising the steps of acquiring a first image of a first person, locating a first segment in the first image comprising at least an eye of the first person, acquiring a second image of a second person, locating a second segment in the second image comprising at least an eye of the second person, the second segment corresponding in relative position and size to the first segment, comparing the second segment with the first segment, and replacing the second segment in the second image with the first segment if the comparison gives a difference that is smaller than a pre-defined threshold.

The present invention exploits the fact that the area around the borders of the eye is homogenous, i.e. pixels belonging to the area around the eye region all have essentially the same colour value (the same luminance and chrominance value), because it is all skin. This fact makes it much easier to locally overwrite facial pixels and make a transition with the spatial neighborhood without making it look unnatural. Additionally, a small error in the positioning of the eye bitmaps results only in a slight displacement of the eyes which proves to be hardly visible. Furthermore, the replacement of the second segment with the first segment only if a comparison between them results in a difference smaller than a pre-defined threshold provides for improvements in the acceptance of a resulting image (the resulting image looks natural) as cases when e.g. the user blinks and/or moves his/her head from side to side will be excluded, i.e. no replacements will take place. Accordingly, the present invention allows for replacements of segments of the face with pre-recorded corresponding segments having characteristics for improving eye-to-eye contact in e.g. a near-end/far-end user video conferencing system.

The first image may e.g. be acquired during a “training phase” wherein the user is asked to “look straight into the camera”, e.g. the direction of gaze of the eye comprised in the first segment is essentially perpendicular to the image plane of the first image. However, the first image may also be acquired during an automatic process in which a plurality of images of the first person are acquired and from which one image is selected wherein the direction of gaze of the eye of the first person is essentially perpendicular to the image plane, that is, the first person is looking straight into the camera.

Additionally, it is not necessary to store the full first image in which the user looks straight into the camera, but it to only store the first segment, possibly also comprise the corresponding eye brow, thereby minimizing the storage capacity needed for the image processing system. The first and/or the second images may be captured as single still images or as a sequence of images, such as from a video stream. Accordingly, the inventive method may be used both in relation to still images and video sequences, such as for example real time video sequences from a video conferencing and/or video telephony application.

In an alternative embodiment, the first image may be acquired during a process wherein the first image is acquired with one camera and the second image is acquired with a different camera. Accordingly, the first and the second person may not have to be the same person and it may thus be possible to allow for replacement of a second person's eyes with a first person's eyes, e.g. the replacements of a second person's eyes with a celebrity person's eyes. However, typically the first and the second person are the same person.

For further improving the natural look of the resulting image it may be possible to allow blending of the second segment with the first segment together with the step of replacing the second segment in the second image with the first segment. Such a blending may comprise using a pre-defined look-up table for allowing alpha blending of the first and the second segment.

According to another aspect of the present invention there is provided an image processing system comprising a camera and a control unit arranged in communicative connection, wherein the control unit is adapted to acquiring a first image of a person using the camera, locating a first segment in the first image comprising at least an eye of the person, acquiring a second image of the person, locating a second segment in the second image comprising at least an eye of the second person, the second segment corresponding in relative position and size to the first segment, comparing the second segment with the first segment, and replacing the second segment in the second image with the first segment if the comparison gives a difference that is smaller than a pre-defined threshold. This aspect of the invention provides similar advantages as discussed above in relation to the previous aspect of the invention.

The image processing system may according to one embodiment comprise a control unit in the form of a computer, and the camera may be a web camera connected to the computer. However, the control unit may also be integrated with the camera, thereby forming a stand-alone implementation.

According to a still further aspect of the present invention, there is provided a computer program product comprising a computer readable medium having stored thereon computer program means for causing a computer to provide an image processing method, wherein the computer program product comprises code for acquiring a first image of a person, code for locating a first segment in the first image comprising at least an eye of the person, code for acquiring a second image of the person, code for locating a second segment in the second image comprising at least an eye of the second person, the second segment corresponding in relative position and size to the first segment, code for comparing the second segment with the first segment, and code for replacing the second segment in the second image with the first segment if the comparison gives a difference that is smaller than a pre-defined threshold. This aspect of the invention provides similar advantages as discussed above in relation to the previous aspects of the invention.

The computer is preferably a personal computer, and the computer readable medium is one of a removable nonvolatile random access memory, a hard disk drive, a floppy disk, a CD-ROM, a DVD-ROM, a USB memory, or a similar computer readable medium known in the art. Also, the first and the second images may be acquired using a camera connected to the computer.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 illustrates the spatial misalignment problem in a typical video conferencing system, and

FIG. 2 shows a conceptual flow chart of the method according to the invention.

### DETAILED DESCRIPTION OF THE EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

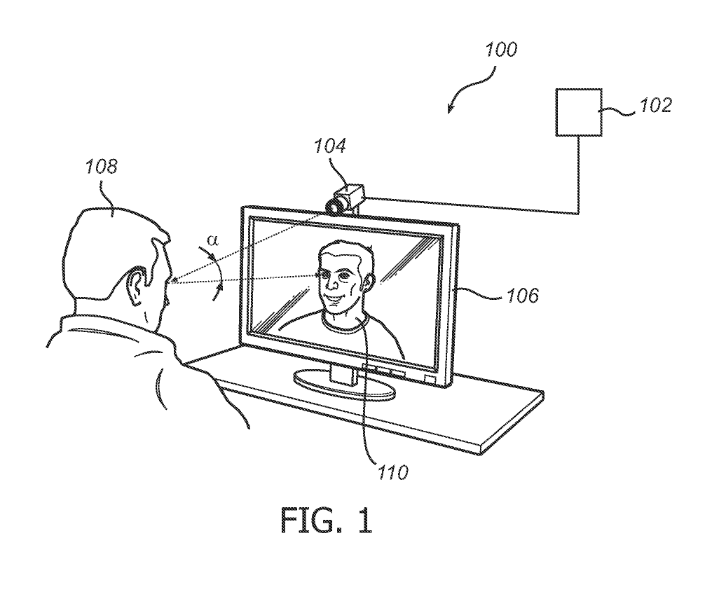

Referring now to the drawings and to FIG. 1 in particular, there is depicted a part of a typical image processing system, such as a video conferencing system 100, comprising a control unit, such as a personal computer 102, a camera 104 and a display screen 106. In FIG. 1 two users, a first near-end user 108 and a second far-end user 110 engage in video conferencing using the video conferencing system 100. As understood, the far-end user 110, having his image displayed on the near-end user's 108 display screen 106 has on his side corresponding equipment, e.g. a computer, a camera and a display screen on his end. The transmission used for communication of information between the near-end user 108 and the far-end user 110 using the video conferencing system 100 may e.g. take using a local (LAN) or a global area network, such as the Internet.

In operation of the typical video conferencing system 100, the near-end user 108 will look essentially straight at the image of the far-end user 110 on the near-end users display screen 106, and accordingly focus his eye gaze at an error angle α in comparison to straight into the camera 104. As a result, the far-end user 110 will be provided, on his display screen, with an image of the near-end user 108 where the near-end user 108 will be “looking downward” and not straight towards the far-end user 110. The error angle in eye gaze will be α.

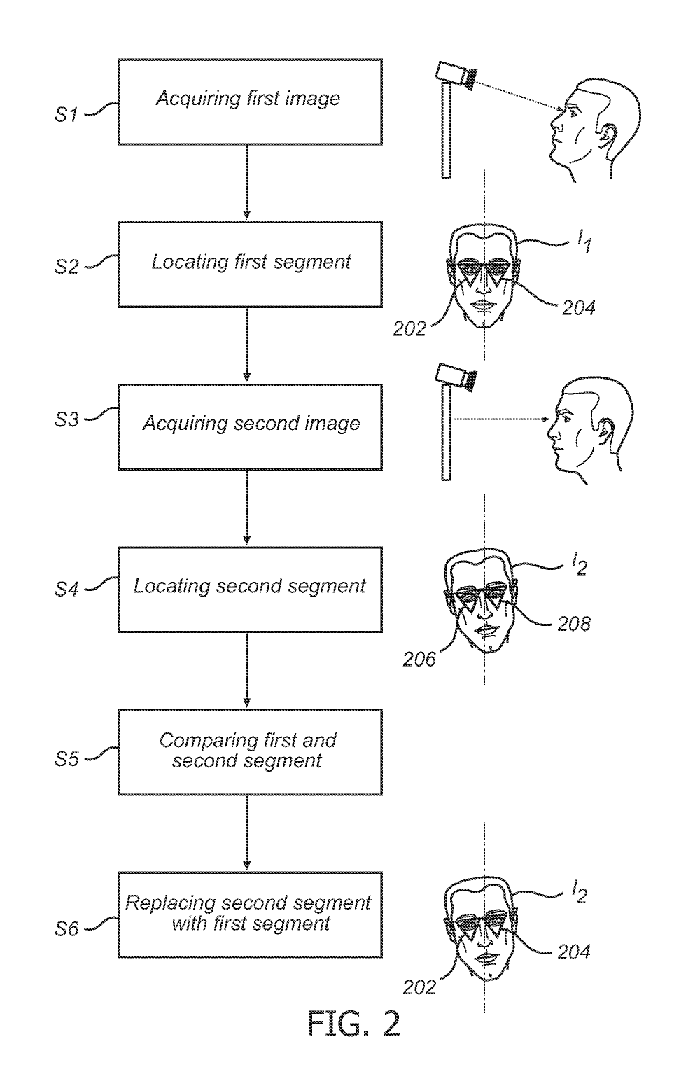

In operation of a video conferencing system 100 making use of the inventive method, with reference in parallel to FIG. 2, there is provided a way of compensating for the eye gaze error angle α and thus improving eye contact between the near-end user 108 and the far-end user 110.

In a first step, S1, a first image I₁ of a person is acquired using a camera, such as camera 104. The acquisition of the first image I₁ should preferably take place when the user looks essentially into the camera, i.e. having an eye gaze an error angle α=approximately 0, however it may be possible to allow for some deviation. The user may perform acquisition of the first image I₁ while looking into the camera or it could be triggered by automatic eye gaze estimation.

In a second step S2, a first segment (in the illustrated embodiment a first segment for each eye) 202, 204 in the first image I₁ is located, each of the first segments 202, 204 comprising at least an eye of the person. The face region may be determined by a face finding and tracking algorithm which provides the coordinates of the face region, such as by using for example an Active Appearance Model (AAM) on the face. The AAM provides the (x,y)-coordinates of a number of face feature points. From the AAM feature point coordinates it may be possible to compute the coordinates of two for example triangularly shaped segments 202, 204 include the eyes and eyebrows. The coordinates of the corners of the triangles may be calculated by a given fixed linear combination of the stable coordinates of the face features in the face. The pixel values inside the triangles are stored for later use.

Step S1 and S2 may take place at any time and the first image I₁ and/or only the first segments 202, 204 may be stored for later use. The third step, S3, may thus not take place directly following steps S1 and S2, but may take place at a later time when e.g. using a video conferencing system 100 comprising the functionality of the invention. Accordingly, in step S3, a second image I₂ will be acquired of the person, using the same (or another) camera as used for acquiring the first image I₁. The second image 12 is preferably acquired and processed in real time when using the video conferencing system 100. Step S3 and step S4 essentially correspond to step S1 and S2 respectively, however, in step S4 and the locating of second segments 206, 208 the person will not likely look into the camera as in conference, and an eye gaze error angle α will be present. As discussed above, the second segment corresponds in relative position and size to the first segment. Additionally, the second segment may also correspond in orientation with the first segment. The method for determining second triangularly shaped segments 206, 208 corresponding in shape and position to the first triangularly shaped segments 202, 204 may correspond to the method used in step S2.

It should be noted that differences in size and possibly angle of the second triangularly shaped segments 206, 208 in relation to the first triangularly shaped segments 202, 204 may be handled by means e.g. a morphing method, where the size and angle of the first triangularly shaped segments 202, 204 are matched to the respective second triangularly shaped segments 206, 208. The morphing may be done by an affine transformation of the first triangularly shaped segments 202, 204.

In step S5 following step S4, a comparison is performed where the respective second triangularly shaped segments 206, 208 are compared to the first triangularly shaped segments 202, 204. For example, a comparison error number may be determined by calculating the sum of absolute difference (SAD) of the pixel luminance values in the triangular eye regions between the (possibly morphed) first triangularly shaped segments 202, 204 and the respective second triangularly shaped segments 206, 208 (from the e.g. live video).

Finally, in step S6, the second triangularly shaped segments 206, 208 in the second image I₂ will be replaced with the respective first triangularly shaped segments 202, 204, thereby forming a second image I₂ comprising the first triangularly shaped segments 202, 204. However, the replacement will only take place if the comparison gives a difference that is smaller than a pre-defined threshold. This ensures that the second image I2 will be protected against incorrectly replacing the pixels in case of e.g. the shape model is misaligned, the user blinks with his eye(s) and/or the face in the second image I₂ is not frontal. To prevent visibility of the transition between original pixels and replaced pixels (i.e. from second and first segments, respectively) it may be possible to blend the pixels of the respective segments for example using a blending algorithm.

Even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. For example, the inventive method may also be used in conjunction with “self recording” of a video sequence, for example for publication on the Internet at e.g. YouTube. In such a case, the resulting video sequence will not be transmitted to a far-end user but instead only recorded and stored for later publication. Additionally, the method may alternatively be used to replace eyes in live video by for instance funny eyes, differently colored eyes, shades, or a black bar. This feature can be used to hide or change your own identity during video telephony.

Furthermore, in the claims, the word “comprising” does not exclude other elements or steps, and the indefinite article “a” or “an” does not exclude a plurality. Any biased reference in the text is made merely for the sake of brevity and convenience.

1. A method for an image processing system (100), the method comprising the steps of:
acquiring (51) a first image (I₁) of a first person;
locating (S2) a first segment (202, 204) in the first image (I₁) comprising at least an eye of the first person;
acquiring (S3) a second image (I₂) of a second person;
locating (S4) a second segment (206, 208) in the second image (I₂) comprising at least an eye of the second person, the second segment corresponding in relative position and size to the first segment (202, 204);
comparing (S5) the second segment (206, 208) with the first segment (202, 204), and
replacing (S6) the second segment (206, 208) in the second image (I₂) with the first segment (202, 204) if the comparison gives a difference that is smaller than a pre-defined threshold.

2. Method according to claim 1, wherein the first and the second person are the same person.

3. Method according to claim 1, wherein the first (202, 204) and the second segment (206, 208) further comprise the corresponding eye brow.

4. Method according to claim 1, wherein the directivanon of gaze of the eye comprised in the first segment (202, 204) is essentially perpendicular to the image plane of the first image (I₁).

5. Method according to claim 1, further comprising the steps of:
acquiring a plurality of images of the first person;
determining the direction of gaze of the eye of the first person for each of the plurality of images; and
selecting one of the plurality of images wherein the direction of gaze of the eye of the first person is essentially perpendicular to the image plane.

6. Method according to claim 1, wherein the step of replacing the second segment (206, 208) in the second image (I₂) with the first segment (202, 204) comprises blending the second segment (206, 208) with the first segment (202, 204).

7. Image processing system (100) comprising a control unit (102) and a camera (104) arranged in communicative connection, wherein the control unit (102) is adapted to:
acquiring a first image (I₁) of a person using the camera (102);
locating a first segment (202, 204) in the first image (I₁) comprising at least an eye of the person;
acquiring a second image (I₂) of the person;
locating a second segment (206, 208) in the second image (I₂) comprising at least an eye of the second person, the second segment (206, 208) corresponding in relative position and size to the first segment (202, 204);
comparing the second segment (206, 208) with the first segment (202, 204), and replacing the second segment (206, 208) in the second image (I₂) with the first segment (202, 204) if the comparison gives a difference that is smaller than a pre-defined threshold.

8. Image processing system (100) according to claim 7, wherein the camera (104) is a web camera.

9. Image processing system (100) according to claim 7, wherein the control unit (102) is integrated with the camera (104).

10. Computer program product comprising a computer readable medium having stored thereon computer program means for causing a computer to provide an image processing method, wherein the computer program product comprises:
code for acquiring a first image of a person;
code for locating a first segment in the first image comprising at least an eye of the person;
code for acquiring a second image of the person;
code for locating a second segment in the second image comprising at least an eye of the second person, the second segment corresponding in relative position and size to the first segment;
code for comparing the second segment with the first segment, and
code for replacing the second segment in the second image with the first segment if the comparison gives a difference that is smaller than a pre-defined threshold.

11. Computer program product according to claim 10, wherein the first and the second images are acquired using a camera connected to the computer.
